(19) United States
(12) Patent Application Publication
(10) Pub. No.: US 2012/0062696 A1
(43) Pub. Date: Mar. 15, 2012

(54) ELECTRONIC DEVICE WITH IMAGE REPRODUCTION FUNCTION AND METHOD THEREOF

(75) Inventor: PING-YANG CHUANG, Tu-Cheng (TW)

(73) Assignee: HON HAI PRECISION INDUSTRY CO., LTD., Tu-Cheng (TW)

(21) Appl. No.: 12/972,508

(22) Filed: Dec. 19, 2010

(30) Foreign Application Priority Data
Sep. 10, 2010 (TW) 99130631

(51) Int. Cl. H04N 7/00

(52) U.S. Cl. 348/39; 348/E07.091

(57) ABSTRACT

An electronic device with an image reproduction function includes an input unit for receiving a user operation, a storage unit, a display unit and a processing unit. The storage unit stores a plurality of images, each of which includes positioning information. The processing unit includes a positioning sensor module, an image acquiring module, a detection and an image display module. The positioning sensor module acquires positioning information of the electronic device. The image acquiring module acquires image(s) from the storage unit. The detection module acquires the positioning information of each acquired image, and compares whether the positioning information of the acquired image matches the positioning information of the electronic device. The image display module displays the acquired image(s) whose positioning information matches the positioning information of the electronic device on the display unit.

### BACKGROUND

1. Technical Field

The present disclosure relates to electronic devices and, particularly, to an electronic device having an image reproduction function and a method for providing the function.

2. Description of Related Art

In general, it is difficult to accurately index and digitally stitch together image files from a miscellany of like scenic images captured from the same geographic location.

### BRIEF DESCRIPTION OF THE DRAWINGS

FIG. 1 is a block diagram of a hardware infrastructure of an electronic device with image reproduction function in accordance with an exemplary embodiment.

FIG. 2 is a block diagram of a hardware infrastructure of an electronic device with image reproduction function in accordance with another embodiment.

FIG. 3 shows the electronic device of FIG. 1 or FIG. 2 being rotated at an angle of 360 degrees.

FIG. 4 is a flowchart of a method for providing an image reproduction function implemented by the electronic device of FIG. 1, in accordance with an exemplary embodiment.

### DETAILED DESCRIPTION

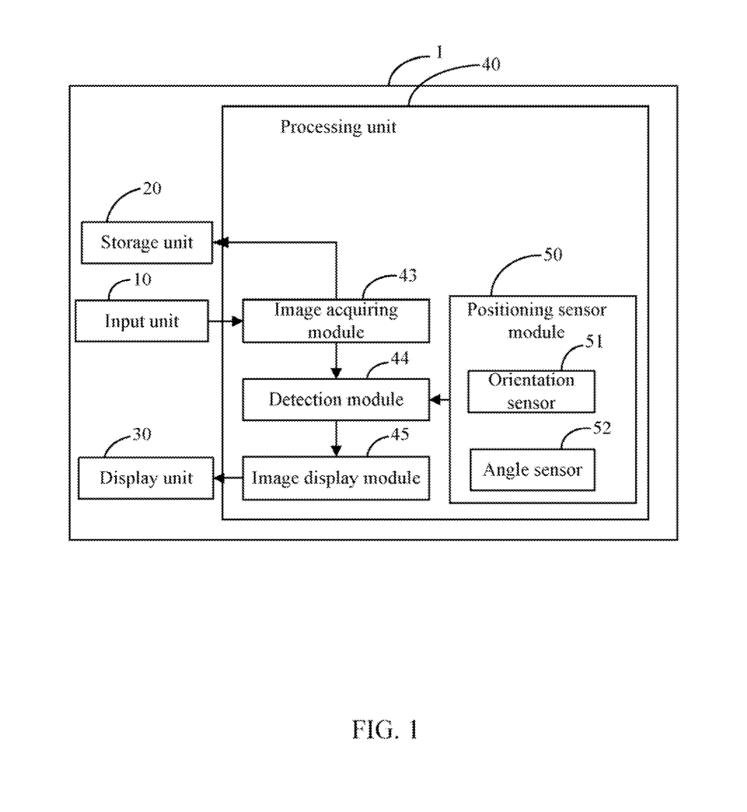

Referring to FIG. 1, an electronic device 1 with image reproduction function is provided. The electronic device 1 includes an input unit 10, a processing unit 40, a storage unit 20, and a display unit 30. In one embodiment, the electronic device 1 is a smart phone. The input unit 10 is for receiving user operations. The storage unit 20 is configured for storing a number of images. The images may be transmitted from other electronic devices, or may be captured by the electronic device 1. Each image includes positioning information. The positioning information may be orientation information or angle information.

The processing unit 40 includes a positioning sensor module 50, an image acquiring module 43, a detection module 44, and an image display module 45. The positioning sensor module 50 is for sensing the electronic device 1 to acquire positioning information of the electronic device 1. The positioning information may be orientation information of the electronic device 1, or angle information between the electronic device 1 and a horizontal surface. In one embodiment, the positioning sensor module 50 includes an orientation sensor 51 and an angle sensor 52. The orientation sensor 51 senses the orientation information of the electronic device 1 on a horizontal surface. The angle sensor 52 senses the angle information between the electronic device 1 and the horizontal surface. The orientation sensor 51 can be an electronic compass.

The image acquiring module 43 acquires image(s) from the storage unit 20 in response to the user operation from the input unit 10.

The detection module 44 detects the positioning information of each acquired image, and compares whether the acquired positioning information of the acquired image(s) matches the positioning information of the electronic device 1.

The image display module 45 displays the acquired image(s) whose positioning information matches the positioning information of the electronic device 1 on the display unit 30.

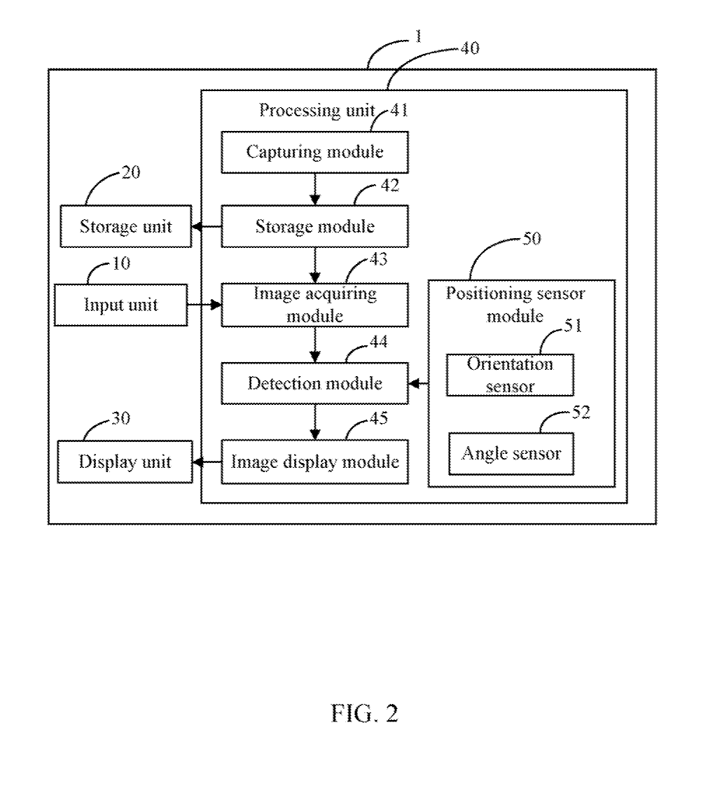

As shown in FIG. 2, in another embodiment, the processing unit 40 further includes a capturing module 41 and a storage module 42. The capturing module 41 captures image(s) in response to the user operation from the input unit 10. In one embodiment, the capturing module 41 is a camera fixed on the electronic device 1, which includes two shooting modes: a single shooting mode and a continuous shooting mode. In the single shooting mode, the capturing module 41 captures only one still image in response to one pressed operation from the user. In the continuous shooting mode, the capturing module 41 captures a series of still images in response to one pressed operation from the user.

The storage module 42 stores the captured image(s) to the storage unit 20. In one embodiment, the storage unit 20 includes a parent folder, which includes a first subfolder and one or more second subfolders. The storage module 42 stores each captured image to the first subfolder in the single shooting mode, and stores the series of captured images to a new second subfolder in the continuous shooting mode. In one embodiment, the image acquiring module 43 selects the first subfolder or the second subfolder from the parent folder, and acquires the image(s) from the selected subfolder in response to the user operation from the input unit 10. Each captured image includes the positioning information associated with the capturing module 41 when capturing. In one embodiment, the positioning information of the captured image includes shooting data. The shooting data includes a camera's focal orientation information (hereinafter, “image orientation information”) and angle information between the capturing module 41 and the horizontal surface (hereinafter, “image angle information”). For example, the capturing module 41 captures the image, the camera points north-east, and the image orientation information is northeast. When the capturing module 41 captures the image, an angle between the camera and the horizontal surface is 45 degrees, and the image angle information is 45 degrees.

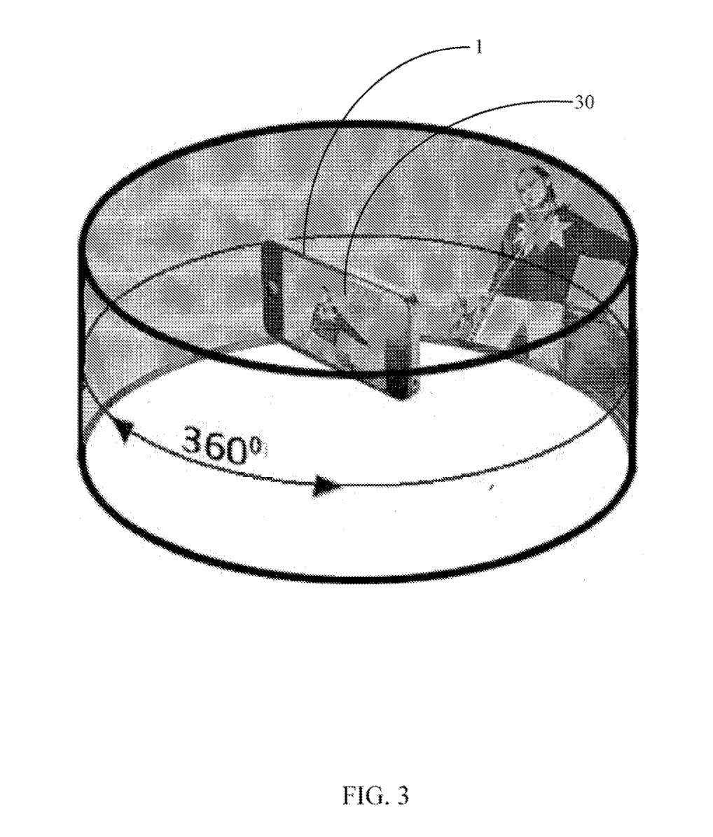

As shown in FIG. 3, in the continuous shooting mode, the electronic device 1 is rotated at an angle of 360 degrees. During the rotation of the electronic device, the capturing module 41 captures a series of still images in response to the user operation. The storage module 42 stores the captured images to a new second subfolder of the storage unit 20. When attempting to display the above captured images, the electronic device 1 selects the second subfolder from the storage unit 20 and acquires the images from the second subfolder in response to the user operation. After the images are acquired, the electronic device 1 is again rotated at the angle of 360 degrees. During rotation of the electronic device 1, the detection module 44 compares the positioning information of the image(s) with the positioning information of the electronic device 1, and the image display module 45 displays the image whose positioning information matches the positioning information of the electronic device 1 on the display unit 30.

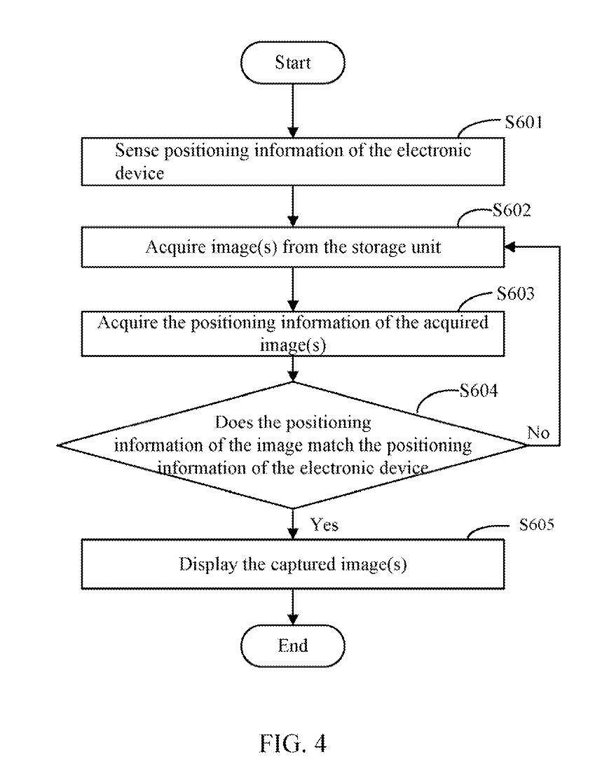

FIG. 4 is a flowchart of a method for providing an image reproduction function implemented by the electronic device in accordance with an exemplary embodiment.

In step S601, the positioning sensor module 50 senses the electronic device 1 to acquire positioning information of the electronic device 1.

In step S602, the image acquiring module 43 acquires image(s) from the storage unit 10 in response to the user operation from the input unit 10.

In step S603, the detection module 44 acquires the positioning information of the acquired image(s).

In step S604, the detection module 44 detects whether the positioning information of the acquired image(s) matches the positioning information of the electronic device 1, if yes, the procedure goes to step S605; if no, the procedure goes to step S602.

In step S605, the image display module 45 displays the acquired image(s) whose positioning information matches the positioning information of the electronic device 1 on the display unit 30.

In another embodiment, the method further includes two steps: the capturing module 41 captures images in response to the user operation from the input unit 10, and the storage module 42 stores the captured images to the storage unit 20.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device with an image reproduction function, comprising:
an input unit for receiving user operations;
a storage unit for storing a plurality of images, each of the images comprising positioning information;
a display unit; and
a processing unit comprising:
a positioning sensor module for sensing the electronic device to acquire a positioning information of the electronic device;
an image acquiring module for acquiring the image(s) from the storage unit in response to the user operation from the input unit;
a detection module for acquiring the positioning information of each acquired image, and comparing whether the positioning information of the acquired image matches the positioning information of the electronic device; and
an image display module for displaying the acquired image(s) whose positioning information matches the positioning information of the electronic device on the display unit.

2. The electronic device as described in claim 1, wherein the processing unit further comprises a capturing module and a storage module, the capturing module is for capturing image(s) in response to the user operation from the input unit; the storage module is for storing the captured image(s) to the storage unit, each captured image comprises the positioning information associated with the capturing module when capturing.

3. The electronic device as described in claim 2, wherein the capturing module is a camera mounted on the electronic device.

4. The electronic device as described in claim 2, wherein the capturing module comprises two shooting modes: a single shooting mode and a continuous shooting mode, the capturing module captures only one still image in response to one pressed operation from the user in the single shooting mode; the capturing module captures a series of still images in response to one pressed operation from the user in the continuous shooting mode, the storage unit comprises a parent folder which includes a first subfolder and one or more second subfolders, the storage module stores each captured image to the first subfolder in the single shooting mode, and stores the series of captured images to a new second subfolder in the continuous shooting mode every time.

5. The electronic device as described in claim 4, wherein the image acquiring module selects the first subfolder or one of the second subfolders from the parent folder, and acquires the image(s) from the selected subfolder in response to the user operation from the input unit, the detection module acquires the positioning information of each acquired image, and compares whether the positioning information of the acquired image(s)matches the positioning information of the electronic device; and the image display module displays the acquired image(s) whose positioning information matches the positioning information of the electronic device on the display unit.

6. The electronic device as described in claim 1, wherein the positioning sensor module comprises an orientation sensor which senses an orientation information of the electronic device on a horizontal surface, the positioning information of each captured image comprises the orientation information.

7. The electronic device as described in claim 1, wherein the positioning sensor module comprises an angle sensor which senses an angle information between the electronic device and a horizontal surface, the positioning information of each captured image comprises the angle information.

8. The electronic device as described in claim 1, wherein the positioning sensor module comprises an orientation sensor and an angle sensor, the orientation sensor senses an orientation information of the electronic device on a horizontal surface, the angle sensor senses an angle information between the electronic device and the horizontal surface, the positioning information of each captured image comprises the orientation information and the angle information.

9. A method having an image reproduction function implemented by an electronic device, wherein the electronic device comprises an input unit for receiving user operations, a display unit, and a storage unit for storing a plurality of images, each of the images comprises a positioning information, the method comprising:
sensing the electronic device to acquire a positioning information of the electronic device;
acquiring the image(s) from the storage unit in response to the user operation from the input unit;
acquiring the positioning information of each acquired image, and comparing whether the positioning information of the acquired image(s) matches the positioning information of the electronic device; and
displaying the acquired image(s) whose positioning information matches the positioning information of electronic device on the display unit.

10. The method as described in claim 9, further comprising:
capturing image(s) in response to the user operation from the input unit; and
storing the captured image(s) to the storage unit, each captured image comprises the positioning information.
